(19) United States
(12) Patent Application Publication
(10) Pub. No.: US 2024/0006675 A1
(43) Pub. Date: Jan. 4, 2024

(54) DETERMINING A LITHIUM-PLATING STATE OF A BATTERY, AND RELATED SYSTEMS, DEVICES AND METHODS

(71) Applicant: Battelle Energy Alliance, LLC, ldaho Falls, ID (US)

(72) Inventors: Tanvir R. Tanim, Idaho Falls, ID (US); Bor-Rong Chen, Idaho Falls, ID (US); Matthew R. Kunz, Idaho Falls, ID (US); Eric J. Dufek, Ammon, ID (US)

(21) Appl. No.: 18/253,194

(22) PCT Filed: Nov. 16, 2021
(86) PCT No.: PCT/US2021/072420

§ 371 Date: May 16, 2023

Related U.S. Application Data
(60) Provisional application No. 63/116,032, filed on Nov. 19, 2020.

(51) Int. Cl. H01M 10/48; H01M 10/42

(52) U.S. Cl. CPC H01M 10/484; H01M 10/425; H01M 2010/4271

(57) ABSTRACT

Various embodiments relate to determining a lithium-plating state of a battery. Various embodiments include a method including: observing a first characteristic of a battery, observing a second characteristic of the battery, and determining, based on the first characteristic and the second characteristic, a lithium-plating state of the battery. In some embodiments, the first characteristic and the second characteristic may each be one of: a rate of change of the capacity per cycle over a number of cycles, end-of-charge rest voltage over a number of cycles, and a coulombic efficiency over a number of cycles. Related devices are also disclosed.

### CROSS-REFERENCE TO RELATED APPLICATIONS

This application is a national phase entry under 35 U.S.C. § 371 of International Patent Application PCT/US2021/072420 filed Nov. 16, 2021, designating the United States of America and published as International Patent Publication WO 2022/109539 A1 on May 27, 2022, which claims the benefit under Article 8 of the Patent Cooperation Treaty to U.S. Patent Application Ser. No. 63/116,032, filed Nov. 19, 2020.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

Embodiments of the present disclosure relate generally to determining a lithium-plating state of a battery.

### BACKGROUND

As lithium-ion batteries (LiBs) become more and more widely adopted in consumer electronics, transportation and stationary applications, capabilities to manage battery performance and predict life and safety have become important. Early detection of battery-aging phenomena and the consequent implications to battery performance, battery life, and battery safety are important, e.g., for avoiding warranty and safety-related liabilities. Li-plating is an undesired aging phenomenon that significantly reduces performance and safety of LiBs. Early detection of Li-plating and may be important. As the application area of LiB is broadening, the operating regime is also getting more diverse and aggressive to include low-temperature and fast-charging conditions. Therefore, it is important to develop more robust and reliable methods to detect Li-plating early.

### BRIEF SUMMARY

Various embodiments may include:

A method comprising: observing a first characteristic of a battery; observing a second characteristic of the battery; and determining, based on the first characteristic and the second characteristic, a lithium-plating state of the battery.

A battery-management system comprising: a processor; and a computer-readable medium comprising computer executable instructions that, when executed via the processor, cause the processor to perform operations, the operations comprising: observing a first characteristic of a battery; observing a second characteristic of the battery; determining, based on the first characteristic and the second characteristic, a lithium-plating state of the battery.

A device comprising: a battery; and a battery management system comprising: a processor; and a computer-readable medium comprising computer executable instructions that, when executed via the processor, cause the processor to perform operations, the operations comprising: observing a first characteristic of a battery; observing a second characteristic of the battery; and determining, based on the first characteristic and the second characteristic, a lithium-plating state of the battery.

### BRIEF DESCRIPTION OF THE DRAWINGS

While this disclosure concludes with claims particularly pointing out and distinctly claiming specific embodiments, various features and advantages of embodiments within the scope of this disclosure may be more readily ascertained from the following description when read in conjunction with the accompanying drawings, in which:

FIG. 1 and FIG. 2 include graphs illustrating capacity loss (ΔQ) for a number of example cells over a number of cycles (N).

FIG. 3 and FIG. 4 include graphs illustrating the first derivative of capacity loss (dQ/dN) for a number of example cells over a number of cycles (N).

FIG. 5 and FIG. 6 include graphs illustrating the coulombic efficiency (CE) for a number of example cells over a number of cycles (N).

FIG. 7 and FIG. 8 include graphs illustrating the end-of-charge rest voltage (EOCV) for a number of example cells over a number of cycles (N).

FIG. 9, FIG. 10, and FIG. μ include graphs illustrating post-charge OCV relaxation of example cells over a number of cycles.

FIG. 12 includes a plot illustrating capacity fade per dV/dt of example cells.

FIG. 13 includes a plot illustrating Li coverage per dV/dt of example cells.

FIG. 14 illustrates an example decision-making framework according to one or more embodiments of the disclosure.

FIG. 15 is a flowchart of an example method, in accordance with various embodiments of the disclosure.

FIG. 16 is a functional-block diagram of an example device, according to one or more embodiments of the present disclosure.

FIG. 17 illustrates a block diagram of an example device that may be used to implement various functions, operations, acts, processes, and/or methods, in accordance with one or more embodiments.

FIG. 18 includes a plot illustrating overvoltage of example cells.

### DETAILED DESCRIPTION

In the following detailed description, reference is made to the accompanying drawings, which form a part hereof, and in which are shown, by way of illustration, specific examples of embodiments in which the present disclosure may be practiced. These embodiments are described in sufficient detail to enable a person of ordinary skill in the art to practice the present disclosure. However, other embodiments may be utilized, and structural, material, and process changes may be made without departing from the scope of the disclosure.

The illustrations presented herein are not meant to be actual views of any particular method, system, device, or structure, but are merely idealized representations that are employed to describe the embodiments of the present disclosure. The drawings presented herein are not necessarily drawn to scale. Similar structures or components in the various drawings may retain the same or similar numbering for the convenience of the reader; however, the similarity in numbering does not mean that the structures or components are necessarily identical in size, composition, configuration, or any other property.

The following description may include examples to help enable one of ordinary skill in the art to practice the disclosed embodiments. The use of the terms “exemplary,” “by example,” and “for example,” means that the related description is explanatory, and though the scope of the disclosure is intended to encompass the examples and legal equivalents, the use of such terms is not intended to limit the scope of an embodiment of this disclosure to the specified components, steps, features, functions, or the like.

It will be readily understood that the components of the embodiments as generally described herein and illustrated in the drawing could be arranged and designed in a wide variety of different configurations. Thus, the following description of various embodiments is not intended to limit the scope of the present disclosure, but is merely representative of various embodiments. While the various aspects of the embodiments may be presented in drawings, the drawings are not necessarily drawn to scale unless specifically indicated.

Furthermore, specific implementations shown and described are only examples and should not be construed as the only way to implement the present disclosure unless specified otherwise herein. Elements, circuits, and functions may be depicted by block diagram form in order not to obscure the present disclosure in unnecessary detail. Conversely, specific implementations shown and described are exemplary only and should not be construed as the only way to implement the present disclosure unless specified otherwise herein. Additionally, block definitions and partitioning of logic between various blocks is exemplary of a specific implementation. It will be readily apparent to one of ordinary skill in the art that the present disclosure may be practiced by numerous other partitioning solutions. For the most part, details concerning timing considerations and the like have been omitted where such details are not necessary to obtain a complete understanding of the present disclosure and are within the abilities of persons of ordinary skill in the relevant art.

Those of ordinary skill in the art would understand that information and signals may be represented using any of a variety of different technologies and techniques. For example, data, instructions, commands, information, signals, bits, and symbols that may be referenced throughout this description may be represented by voltages, currents, electromagnetic waves, magnetic fields or particles, optical fields or particles, or any combination thereof. Some drawings may illustrate signals as a single signal for clarity of presentation and description. It will be understood by a person of ordinary skill in the art that the signal may represent a bus of signals, wherein the bus may have a variety of bit widths and the present disclosure may be implemented on any number of data signals including a single data signal. A person having ordinary skill in the art would appreciate that this disclosure encompasses communication of quantum information and qubits used to represent quantum information.

The various illustrative logical blocks, modules, and circuits described in connection with the embodiments disclosed herein may be implemented or performed with a general purpose processor, a special purpose processor, a Digital Signal Processor (DSP), an Integrated Circuit (IC), an Application Specific Integrated Circuit (ASIC), a Field Programmable Gate Array (FPGA) or other programmable logic device, discrete gate or transistor logic, discrete hardware components, or any combination thereof designed to perform the functions described herein. A general-purpose processor (may also be referred to herein as a host processor or simply a host) may be a microprocessor, but in the alternative, the processor may be any conventional processor, controller, microcontroller, or state machine. A processor may also be implemented as a combination of computing devices, such as a combination of a DSP and a microprocessor, a plurality of microprocessors, one or more microprocessors in conjunction with a DSP core, or any other such configuration. A general-purpose computer including a processor is considered a special-purpose computer while the general-purpose computer is configured to execute computing instructions (e.g., software code) related to embodiments of the present disclosure.

Some embodiments may be described in terms of a process that is depicted as a flowchart, a flow diagram, a structure diagram, or a block diagram. Although a flowchart may describe operational acts as a sequential process, many of these acts can be performed in another sequence, in parallel, or substantially concurrently. In addition, the order of the acts may be re-arranged. A process may correspond to a method, a thread, a function, a procedure, a subroutine, or a subprogram, without limitation. Furthermore, the methods disclosed herein may be implemented in hardware, software, or both. If implemented in software, the functions may be stored or transmitted as one or more instructions or code on computer-readable media. Computer-readable media includes both computer storage media and communication media including any medium that facilitates transfer of a computer program from one place to another.

Early detection of battery-aging phenomena and the consequent implications to battery performance, battery life, and battery safety may be important. Li-plating is an undesired aging phenomenon that significantly reduces performance and safety of LiBs. Early detection of Li-plating may be important.

Reliance on measurements of a single characteristic of a battery (or of battery performance) may be insufficient to provide enough information to determine battery-aging phenomena (e.g., Li-plating), especially in light of diverse operating and use conditions of batteries. Detection methods relying on a single characteristic could result in detection delayed until significant Li-plating has occurred or even failure to detect Li-plating.

Early-stage detection of Li-plating may be important because Li-plating may induce irreversible degradation to battery life and safety—e.g., path-dependent accelerated aging, triggering new aging modes or mechanisms, and internal short-circuits, etc. Without early diagnosis of Li-plating, a corrective action may not be possible. Thus, there is a need for an efficient and robust Li-plating detection method for industries that use LiBs as a primary or secondary source of power. This early and robust detection of Li-plating could also improve battery design in the developmental phase, reducing inefficient use of time and resources and allowing faster technology evaluation.

Various embodiments of this disclosure relate to determining a Li-plating state (or other aging phenomena) using multiple (e.g., two or more) different observed characteristics of a battery or battery performance. In the present disclosure, the term “electrochemical signature” or “EC signature” may be used to refer to observable characteristics of a battery or battery performance. EC signatures may include measurements over a number of cycles. Various embodiments use multiple EC signatures to avoid false negative cases while providing more-reliable and earlier Li-plating detection capability than is achievable using a single EC signature.

In some embodiments, a decision tree may describe factors considered in determining Li-plating. The decision tree may be based on experimentally measured EC signatures related to the lithium-plating state (e.g., Li-plating or no Li-plating). In the present disclosure, the term “no Li-plating” may refer to battery aging exhibiting solid electrolyte interphase (SEI)-related aging or a benign aging. In the present disclosure, the term “Li-plating” may refer to formation of lithium on an anode of a battery. Determining that Li-plating has occurred may include determining a probability that Li-plating has occurred within a battery.

In some embodiments, inputs of the decision tree may include the charge-discharge cycle's capacity (Q) with respect to cycle number (N), and time rate of post-charge voltage (V) relaxation with respect to cycle number (N). These measured primary variables (Q with respect to N and V relaxation with respect to N) may be converted into secondary variables—e.g., coulombic efficiency (CE), the first derivative of voltage with respect to time (dV/dt), and the first derivative of capacity with respect to cycle number (dQ/dN), and “voltage at the end of the rest period after charge” or “end-of-charge rest voltage” (EOCV). The decision tree may consider distinct features of these secondary variables, such as linearity, rising and falling trends with cycling and the correlation with capacity fade, and the presence of an inflection point, etc. Threshold values for these secondary variables can be set based on experimental verification of plating or no plating.

In some embodiments, a machine-learning (ML) algorithm based on the decision tree may be used to determine Li-plating (or other aging phenomena). In some embodiments, the decision tree may be designed in such a way that it aligns with the ML classification problem, where the response variable is a Boolean vector of a normal SEI-dominant or Li-plating case. The final output of the ML algorithm may provide a decision on Li-plating or normal SEI growth (i.e., benign aging) with a level of certainty.

For example, a logistic elastic net model-based ML-framework may be used to determine Li-plating. The ML-framework may be configured to collect and filter primary variables and then automatically generate secondary variables for an unbiased decision requiring less data in a relatively short time, e.g., compared with other techniques of evaluating Li-plating.

In some embodiments, the ML-framework may take raw EC signatures as inputs. In these or other embodiments, the ML-framework may, additionally or alternatively, take processed EC signatures as inputs. For example, one or more EC signatures may be processed, e.g., it may be determined for each cycle number, whether an EC signature (or its derivative) is linear or non-linear. In some embodiments, to implement the ML-framework, the primary and/or secondary variables may be converted into a set of numeric terms for the state of a variable and whether the derivative, with respect to the cycle number, is linear or non-linear. Some embodiments may use a differentiated first-order autoregressive (AR) model. The differenced portion may allow for the model to account for the derivative with respect to cycle number and to deal with potential stationarity issues in the data. The AR component may be configured to determine the quantified effect that the previous cycle has on the next measurement. Typically, this technique may be used as a form of forecasting the next iteration in a series, but it also gives the magnitude of the lag dependence that corresponds to a specific relationship with respect to time within the series. Thus, ΔQ, CE, and EOCV may be represented as the mean (μ) of the original series and the AR magnitude (Δ) as a set of independent variables for each cell. Both μ and Δ describe the trend in the electrochemical signatures with respect to time (or cycle numbers). More explicitly, μ of the of the original series will account for the initial state—e.g., an average CE is below 100% could be an indicator of Li-plating—while Δ accounts for the time-dependent behavior. That is, if the derivative with respect to cycle number of the EOCV has a trend with respect to time, then this trend could be used to determine Li-plating or SEI-only cases. The μ and Δ values are used as features in a logistic elastic net model, and this results in a set of regression coefficients describing the weight associated with each variable in the prediction of Li plating.

The following equation describes the likelihood of a cell having Li-plating based on the Δ Q, CE, and EOCV signatures derived from training data:

$$P ( Li Plating ) = \frac{1}{1 + {e}^{- ( {0.98}_{int} - 0.05 {CE}_{μ} + 0.35 {CE}_{ϕ} - 1.49 {EOCV}_{μ} + 0.21 {EOCV}_{ϕ} )}}$$

where int is the model intercept, and P is the probability of Li-plating. Therefore, a larger value inside the parenthesis describes a higher probability of Li-plating. In some embodiments, a cell may be classified as a Li-plated case when P>0.5; otherwise, it will be an SEI-dominant case.

EC signatures have been identified that may be indicative of SEI-based aging and Li-plating. Various embodiments use the identified EC signatures to determine Li-plating. Further, some embodiments include an ML-based framework for early detection of Li plating. The identified EC signatures are: charge-discharge cycle's capacity (ΔQ), coulombic efficiency (CE), voltage at the end of the rest period after charge (i.e., end-of-charge rest voltage (EOCV)), and post-charge open-circuit voltage (OCV). Each of the signatures carries specific physical meanings reflecting the aging phenomena.

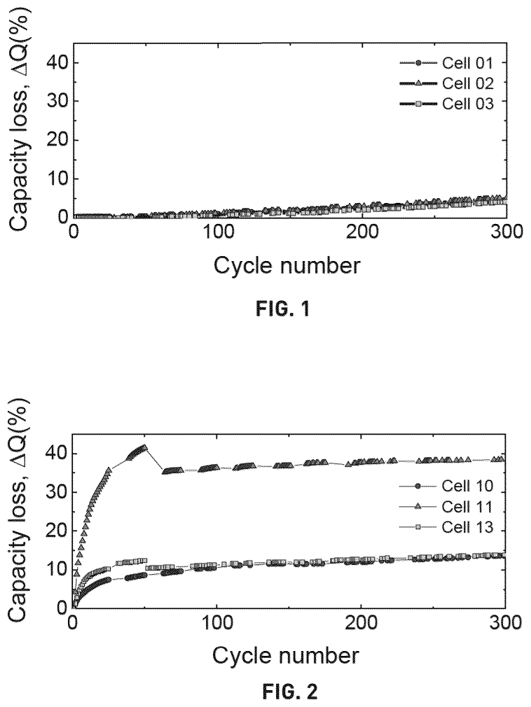

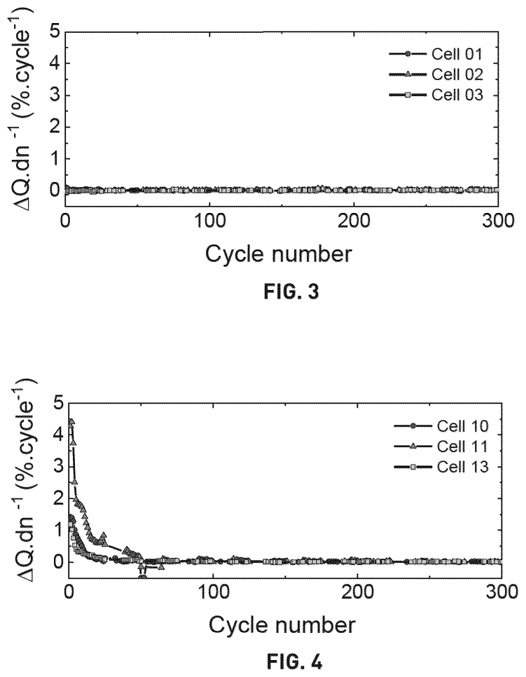

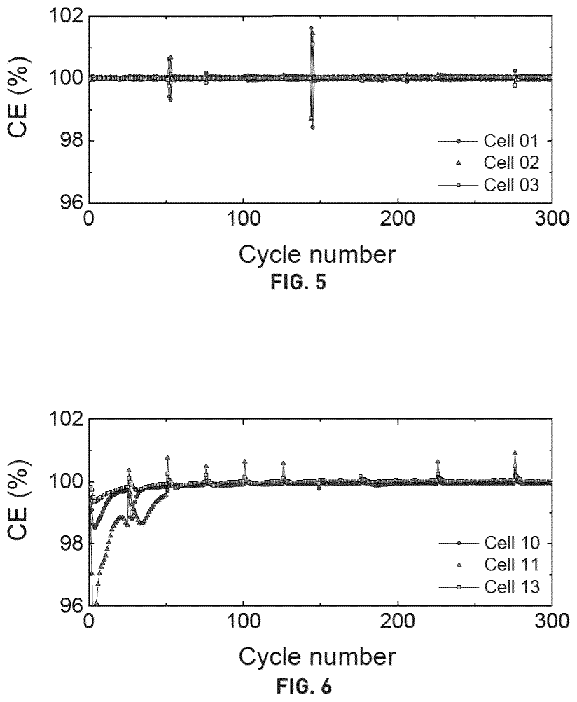

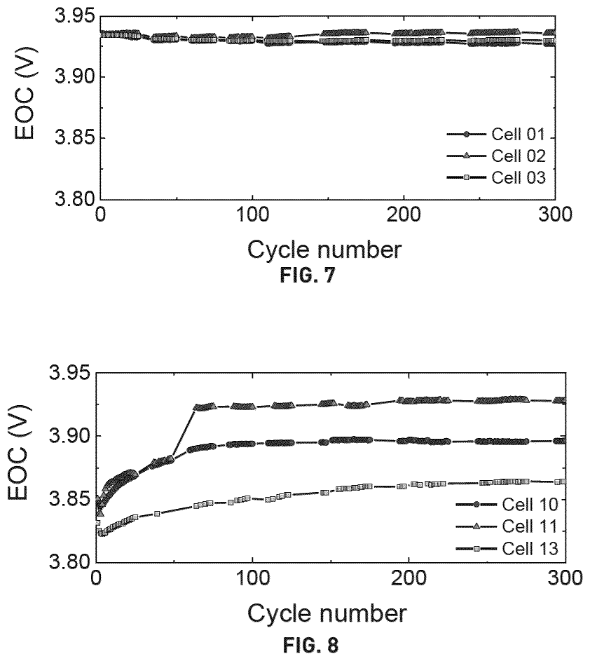

EC-signature features that may be used to differentiate Li-plating from SEI-dominant aging cases include the linearity of: ΔQ, CE, and EOCV. FIG. 1-FIG. 8 illustrates examples of EC signatures exhibiting linearity or non-linearity of ΔQ, CE, and EOCV. The linearity of ΔQ can be further emphasized by taking its first derivative with respect to the cycle number (dQ/dN, where N refers to cycle number). These three EC signatures trended linearly for the SEI-dominant cases, (see FIG. 1, FIG. 3, FIG. 5, and FIG. 7), but showed non-linear curvatures for the Li plating cases, in particular within the first 100-150 cycles (see FIG. 2, FIG. 4, FIG. 6, and FIG. 8). The physical meanings of the signatures and their behavior will be discussed in detail with regard to FIG. 1-FIG. 8.

FIG. 1 and FIG. 2 include graphs illustrating capacity loss (ΔQ) for a number of example cells over a number of cycles (N). FIG. 1 illustrates capacity loss of example cells (e.g., three lithium-ion cells; cell 01, cell 02, and cell 03) exhibiting SEI-dominant aging and FIG. 2 illustrates capacity loss of example cells exhibiting Li-plating (e.g., three lithium-ion cells; cell 10, cell 11, and cell 13).

The shape of a capacity fade (ΔQ) curve reflects how the Li inventory is consumed based on different aging mechanisms. For example, a thickening SEI layer on the anode gradually consumes Li inventory in a linear manner (e.g., as illustrated in FIG. 1), while Li plating leads to rapid Li loss and non-linear capacity decay (e.g., as illustrated in FIG. 2).

The capacity-loss curves of fast-charging cells can be separated based on their linearity. As illustrated in FIG. 1, capacity fade increases in a relatively linear way over the course of 300 cycles of aging, indicating the SEI layer is forming steadily, cycle-by-cycle. Contrary to the linear drop, the capacity-loss curves in FIG. 2 show a non-linear trend growing rapidly during the initial 100 cycles, indicating Li-plating. This increasing trend is gradually decelerated over time. Therefore, the linearity of the capacity-loss trend may be used as a criterion to distinguish Li-plating from SEI-dominant cases.

For example, it may be determined that a battery exhibits solid-electrolyte-interphase-dominant aging based on observing a substantially-linearly-increasing rate of change of the capacity of the battery over the number of cycles, e.g., as illustrated in FIG. 1. Alternatively, it may be determined that a battery exhibits lithium plating based on observing a substantially non-linear rate of change of the capacity of the battery over the number of cycles, e.g., as illustrated in FIG. 2.

FIG. 3 and FIG. 4 include graphs illustrating the first derivative of capacity loss (dQ/dN) for a number of example cells over a number of cycles (N). The FIG. 3 illustrates rates of capacity loss of example cells exhibiting SEI-dominant aging (e.g., three lithium-ion cells; cell 01, cell 02, and cell 03) and FIG. 4 illustrates rates of capacity loss of example cells exhibiting Li-plating (e.g., three lithium-ion cells; cell 10, cell 11, and cell 13).

The difference between the linear and non-linear trends described with regard to FIG. 1 and FIG. 2 can be more distinctively separated by taking the first derivative of capacity loss with respect to the number of cycles (see FIG. 3 and FIG. 4), where the non-linearity is reflected by the non-zero values of the differential capacity loss.

FIG. 5 and FIG. 6 include graphs illustrating the coulombic efficiency (CE) for a number of example cells over a number of cycles (N). FIG. 5 illustrates CE of example cells exhibiting SEI-dominant aging (e.g., three lithium-ion cells; cell 01, cell 02, and cell 03) and FIG. 6 illustrates CE of example cells exhibiting Li-plating (e.g., three lithium-ion cells; cell 10, cell 11, and cell 13).

Coulombic efficiency (CE) of a cell is defined as the ratio between discharge capacity and charge capacity within the same cycle, reflecting the loss of Li between the intercalation/de-intercalation process. Under ideal battery usage of a cell with a graphite anode, CE should be close to 100%, while a lower CE is typically considered an indication of Li plating. For cells dominated by SEI growth, the CE stays at approximately 100% over the course of aging (see FIG. 5). Li-plated cells exhibit reduced CE and a non-linear trend that may last up to ˜100 cycles. Upon continual cycling, the trend of CE keeps going upward and eventually stabilizes back to 100% (see FIG. 6). Therefore, tracking CE in a cycle-by-cycle manner, specifically in the initial cycling, provides information allowing early detection of Li plating.

Additionally, CE exhibits a curved trend right after each of the reference performance test (RPT) periods as discontinuous spikes for the plated cases. During an RPT, charging/discharging performed at C/20, which is significantly slower than under cycle-by-cycle rates. Thus, the lithiation/delithiation of the anode is more efficient during the RPT than in the cycling due to less polarization, thereby causing the spikes in CE. These curvy features after the RPT are sensitive, specifically, for distinguishing cells with less Li plating. In the 4.5C CC-CV (Cell 07, 08, 09) and 7.5C MS5 (Cell 16) cells, the overall trend of CE is relatively flat due to the smaller amount of irreversible Li. Nevertheless, a curve within the few cycles after each of the RPTs is clearly seen, indicating the presence of Li plating. Conversely, in the SEI growth cases, the spikes are visible, but the curvy features are absent, as shown in FIG. 5.

It may be determined that a battery exhibits solid-electrolyte-interphase-dominant aging based on observing CE being substantially the same over the number of cycles, e.g., as illustrated by FIG. 5. Alternatively, it may be determined that a battery exhibits lithium plating based on observing CE being less than 0.995 for one or more cycles; e.g., and the ratio being greater than or equal to 0.995 for one or more subsequent cycles; e.g., as illustrated in FIG. 6.

FIG. 7 and FIG. 8 include graphs illustrating the end-of-charge rest voltage (EOCV) for a number of example cells over a number of cycles (N). The FIG. 7 illustrates EOCV of example cells exhibiting SEI-dominant aging (e.g., three lithium-ion cells; cell 01, cell 02, and cell 03) and FIG. 8 illustrates EOCV of example cells exhibiting Li-plating (e.g., three lithium-ion cells; cell 10, cell 11, and cell 13).

EOCVs were recorded at the end of the 15 minutes rest upon charging and indicate a quasi-equilibrium. The increasing trend of EOCV can be attributed to the mixed Li and anode potential effect. Similar to ΔQ and CE, Li plating also showed EOCV trends. EOCV shows a slight fluctuation in the absence of Li plating (FIG. 7) while exhibiting distinct nonlinearity (FIG. 8) in Li-plated cases. The trend of ΔQ, CE, EOCV are coherent with each other, specifically in the Li-plated case, exhibiting a synchronized change. The initial values of EOCV could vary with state of charge (SOC) due to different charging rates and/or time. For example, the initial EOCV of 4C cells is close to 3.95 V (FIG. 7, charged for 15 minutes) while that for 6C cells (FIG. 8, charged for 10 minutes) is closer to 3.85 V. This initial EOCV does not influence the overall EOCV trend.

Similar to capacity loss and CE, the behavior of EOC can also be roughly divided into two groups, based on trend and linearity. In the linear group, as represented in FIG. 7, the EOCV shows a slight fluctuation (≤0.01 V) and remains relatively stable over the 300 cycles of aging while in FIG. 8, there is a significant, non-linearly increased trend in the range between 0.02 to 0.05 V within the initial 100-150 cycles. These two are the most representative cases for SEI formation and Li plating, respectively. In the significantly Li-plated cases, the progression of the EOC curves are synchronized with those of the corresponding capacity loss and CE curves, demonstrating that multiple signatures have coherent responses to the same aging phenomena. This consistent aging phenomena in the early stage of cycling can be found in fast-charging cells with different cell chemistries as well.

Nevertheless, the behavior of EOCV could be more complex in detail. For 4C 2-step Cell 04 and 06, there is no sign of plating at the end of the 300th cycle. The EOCV stays flat initially, as in other no-plating cases, but rises suddenly around 100 cycles. For Li-plated cases like 6C 2-step Cell 14 and 15, the EOCV trend does not exhibit curvature initially as was seen in the other 6C cases. Instead, the EOCV increases steadily over the course of aging. The variation of EOCV trends may be the result of other aging phenomena occurring in the cells.

It may be determined that a battery exhibits solid-electrolyte-interphase-dominant aging based on observing a substantially unchanging end-of-charge rest voltage over the number of cycles, e.g., as illustrated in FIG. 7. Additionally or alternatively, it may be determined that a battery exhibits solid-electrolyte-interphase-dominant aging based on observing a negative correlation between the end-of-charge rest voltage over the number of cycles (e.g., as illustrated in FIG. 7) and a capacity fade over the number of cycles (e.g., as illustrated in FIG. 1). It may be determined that a battery exhibits lithium plating based on observing a negative second derivative of the end-of-charge rest voltage with respect to cycles over the number of cycles, e.g., as illustrated by the EOCV of Cell 13 in cycles 50-150. Additionally or alternatively, It may be determined that a battery exhibits lithium plating based on observing a positive correlation between the end-of-charge rest voltage over the number of cycles (e.g., as illustrated in FIG. 8) and a capacity fade over the number of cycles (e.g., as illustrated in FIG. 2).

The behaviors of the identified EC signatures (ΔQ, CE, and EOCV) are categorized based on their linearity. The linear trend in (FIG. 1, FIG. 3, FIG. 5, and FIG. 7) is representative of SEI-growth whereas a non-linear trend in (FIG. 2, FIG. 4, FIG. 6, and FIG. 8) indicates Li plating, especially in the first 50-100 cycles. The trend of capacity loss and EOCV data are smoothed to remove any effect due to the RPT while the sharply peaked features caused by RPT in the CE are specifically retained to reveal the non-liner trend after each RPT.

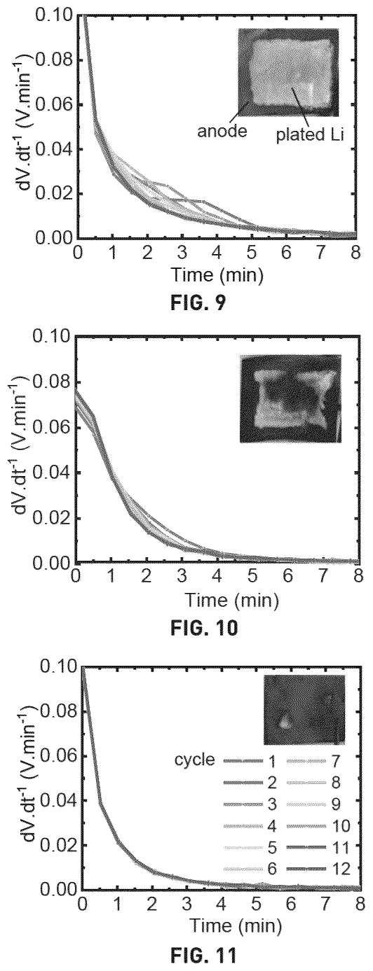

Post-charge OCV relaxation profile and its derivative with respect to time (dV/dt) is another signature related to Li-plating. FIG. 9-FIG. μ illustrates examples of EC signatures exhibiting indicators that may be used to determine Li-plating or SEI-dominant aging.

FIG. 9, FIG. 10, and FIG. 11, include graphs illustrating post-charge OCV relaxation of example cells over a number of cycles. FIG. 9, also includes an optical images of an anodes of a 6C CC-CV (Cell 11). FIG. 10 also includes an optical image of an anode of a 6C CC-CV (Cell 10). FIG. μ also includes an optical image of a 4C CC-CV (Cell 01).

Post-charge OCV may present as an “inflection-point feature” or a peak in the dV/dt profile due to the mixed equilibrium potentials between Li0/Li+ and LixC6/Li+ during and after Li plating, as plated Li chemically intercalates back into the graphite. Testing conditions, charging rate, and SOC may impact the dV/dt signature and its reliability significantly. The dV/dt signatures, tracked cycle-by-cycle, were observed during the early cycling stage, even when other signatures (CE and EOCV) were evident throughout aging. FIG. 9 and FIG. 10 show the early evolution of dV/dt, where an inflection point feature is observed within the first five cycles. This inflection point feature either evolves into an obvious peak (FIG. 9) or remains as a shoulder (FIG. 10) depending on the degree of Li plating (see the optical images of the anodes). As aging proceeds, the dV/dt signature shrinks and disappears, then the dV/dt curve stabilizes for the remainder of cycling. For SEI-dominant cases (FIG. 11), the shape of dV/dt is stable and does not show any inflection point.

The short lived appearance followed by quick disappearance of the dV/dt feature for Li plated cells presents a challenge to identify conditions for Li plating. During early cycling, the plated Li could intercalate back into the graphite if the electrical connection between the bulk graphite and Li remains preserved. Upon aging, electrically isolated Li (“dead” Li) forms and the Li fails to readily intercalate back into the graphite during rest. Without this intercalation process, the subsequent voltage relaxation and the dV/dt feature indicative of reversible Li-stripping could either be minimized or completely absent, even when Li plating exists. The magnitude and position of the dV/dt peak is qualitatively related to the amount of deposited Li on the anode surface.

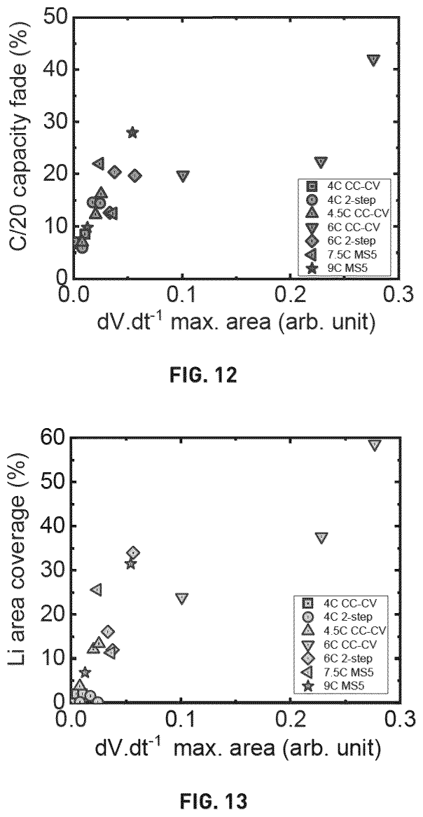

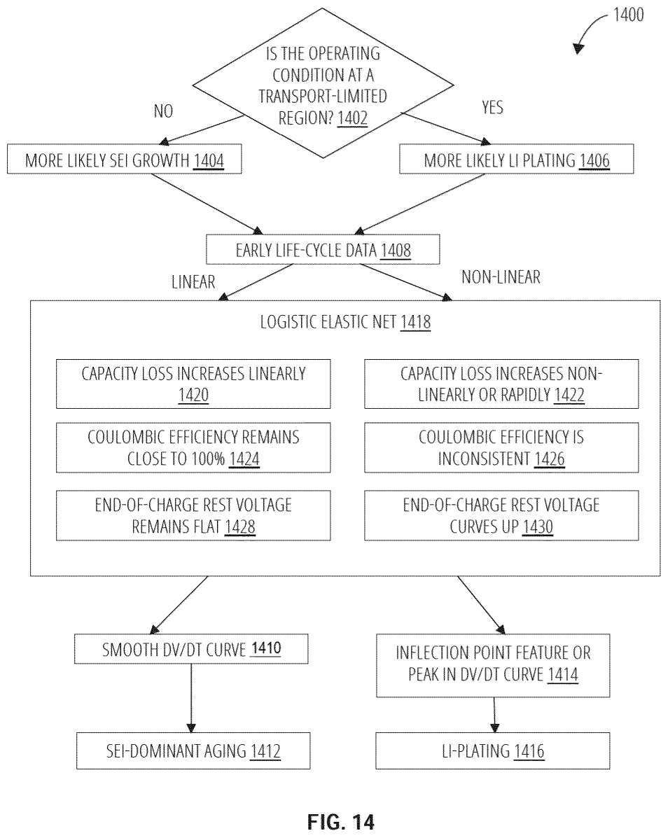

FIG. 12 includes a plot illustrating capacity fade per dV/dt of example cells. FIG. 13 includes a plot illustrating Li coverage per dV/dt of example cells.

The maximum area under the feature is linked to the degree of Li plating, as shown in FIG. 12 and FIG. 13. This correlation indicates the potential of using features which appear during very early cycling to detect and predict the amount of Li plating during later stages. Due to fewer data points, the exact trends in FIG. 12 and FIG. 13 are not yet determinative. To fully use this relationship to better estimate or predict the amount of plated Li, more data points and a more sophisticated approach to quantify the amount of plated Li may be useful.

None of the Li-plated cells showed any distinct dQ/dV or dV/dQ signature either at C/2 discharge steps during cycling or C/20 discharge steps during the RPT. The absence of this feature during early cycling is due to the combined effects of temperature (30° C.) driven enhanced kinetics and the presence of CV hold at the end of charge along with post-charge rest that provided sufficient time for the plated, reversible Li to intercalate into the graphite. The predominance of electrically isolated dead Li completely suppressed the mixed potential phenomenon (or dQ/dV signature) upon continued cycling.

The coherence between the ΔQ, CE, and EOCV trends and the ambiguity of the dV/dt signatures clearly indicate that the EC signatures are dependent on battery design, usage and operating condition and have different reliabilities and detection limits. Therefore, relying on one particular EC signature could result in delayed detection until significant plating has occurred or even failure to detect it at all. For instance, the linearity and trends of ΔQ, CE, and EOCV are generally coherent with each other; however, in cases where the trend is not as apparent, cross-verifying ΔQ, CE, and EOCV signatures provides confidence in decision making. Another example is the interpretation of the dV/dt signature. Although the dV/dt signature shows up in early cycle life, the signal could be ambiguous and unreliable for several groups—e.g., 6C 2-step, 7.5C MS5, and 9C MS5—where other clear evidence of Li plating was present. Therefore, dV/dt may be more informative when combined with other signatures, like ΔQ, EC, and EOCV, to conclusively differentiate an SEI formation-only case. To provide a more robust and accurate decision on Li plating, embodiments disclosed herein consider multiple EC signatures simultaneously.

FIG. 14 illustrates an example decision-making framework 1400 according to one or more embodiments of the disclosure. Various embodiments may include or use decision-making framework 1400 for separating Li plating and SEI-dominant cases in a physically meaningful way. Decision-making framework 1400 may be based on linearity of ΔQ, CE, EOCV, as well as the shape of dV/dt.

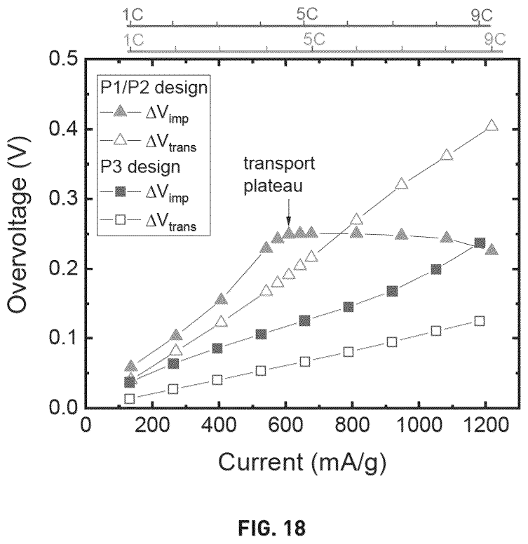

The transport plateau (showed up for moderate loading cells beyond 4C) is used at the first level in decision-making framework 1400 at a block 1402 to evaluate whether a charging condition is more likely to create SEI growth at a block 1404 or Li plating at a block 1406. Additional detail regarding the transport plateau is given with regard to FIG. 18. This level serves as a check point and is not involved in the decision-making process. Decision-making framework 1400 may align with an ML classification problem, in which the response variable is a Boolean vector of an SEI-dominant or Li plating case.

With early life-cycle data indicated at a block 1408, the elements in decision-making framework 1400 may be converted to a set of numeric terms for the state of a specific variable and whether the derivative with respect to the cycle number is linear or non-linear. A differenced first-order autoregressive model (AR(1)) may be used to evaluate decision-making framework 1400. The differenced portion allows the model to account for the numerical derivative with respect to cycle number and to treat potential stationarity issues in the data. The autoregressive component may determine the fraction of effect the previous cycle has on the next measurement. Typically, this method is used as a form of forecasting the next iteration in a series, but it also gives the magnitude of the lag dependence corresponding to a specific relationship with respect to time within the series. Here, ΔQ, CE, and EOCV may be represented as the mean (μ) of the original series, and the autoregressive magnitude (ϕ) as a set of independent variables for each cell. Both μ and ϕ describe the trend of the electrochemical signatures with respect to time (or cycle numbers). More explicitly, μ of the original series will account for the initial state; e.g., an average CE below 100% could be an indicator of Li plating. Similarly, ϕ accounts for the time dependent behavior; e.g., if the derivative with respect to cycle number of the end of charge has a trend with respect to time. This trend could differentiate Li plating from SEI-dominant cases. The μ and ϕ values are used as features in a logistic elastic net classification at a block 1418, generating a set of regression coefficients describing the weight associated with each variable in the prediction of Li plating.

Additionally or alternatively, capacity of the battery may be observed over a number of cycles, e.g., Q over N. The rate of capacity loss; e.g., a first derivative of capacity with respect to cycle number; e.g., dQ/dN may be analyzed at a block 1420 and a block 1422. A substantially non-linear rate of change of the capacity of the battery over the number of cycles; e.g., a substantially non-linear dQ/dN over N; e.g., according to block 1422; may be indicative of Li-plating. Additionally or alternatively, a substantially-linearly-increasing rate of change of the capacity of the battery over the number of cycles, e.g., a substantially linear dQ/dN over N, according to block 1420 may be indicative of SEI-dominant aging.

Additionally or alternatively, a first amount of charge received by the battery during a cycle and a second amount of charge provided by the battery during the cycle may be observed over a number of cycles. Further a ratio between the first amount of charge and the second amount of charge may be determined, e.g., CE. The CE may be analyzed at a block 1424 and a block 1426. The ratio being less than about 0.995 for one or more cycles of the number of cycles and the ratio being greater or equal to than about 0.995 for one or more subsequent cycles of the number of cycles may be indicative of Li-plating according to block 1426. Additionally or alternatively, the ratio being greater than 0.995 for one or more subsequent cycles of the number of cycles may be indicative of SEI-dominant aging according to block 1424.

Additionally or alternatively, end-of-charge rest voltage may be observed over a number of cycles, e.g., EOCV over N. The end-of-charge rest voltage may be analyzed at a block 1428 and a block 1430. A negative second derivative of the end-of-charge rest voltage with respect to cycles over the number of cycles, e.g., d²EOCV/dN²<0 for some N may indicate Li-plating according to block 1430. Additionally or alternatively, a positive correlation between the end-of-charge rest voltage over the number of cycles and a capacity fade over the number of cycles may indicate Li-plating according to block 1430. Additionally or alternatively, a substantially unchanging end-of-charge rest voltage over the number of cycles may indicate SEI-dominant aging according to block 1428. Additionally or alternatively, a negative correlation between the end-of-charge rest voltage over the number of cycles and a capacity fade over the number of cycles may indicate SEI-dominant aging according to block 1428.

The following equation describes the likelihood of a cell having Li plating based on the ΔQ, CE, EOCV signatures derived from the training data:

$$P ( Li Plating ) = \frac{1}{1 + {e}^{- ( {0.98}_{int} - 0.05 {CE}_{μ} + 0.35 {CE}_{ϕ} - 1.49 {EOCV}_{μ} + 0.21 {EOCV}_{ϕ} )}}$$

where int is the model intercept, and P is the likelihood of Li plating. Thus, a larger value inside the parenthesis describes a higher probability of Li plating. The ΔQ variables are not included in the model as the 1-norm penalty of elastic net set the coefficients to zero after cross validation. The absence of ΔQ variables seems to contradict the physical-feature identification, as ΔQ exhibits an obvious trend. However, due to the overall amount of variance explained by CE and EOC, as well as the multicollinearity between the variables, the regression coefficients for ΔQ may be removed. This is also consistent with the fact that ΔQ, CE, and EOCV evolves in a synchronized way during aging. More specifically, the correlation between the ΔQμ and CEμ is −0.995 while the ΔQϕ and CEϕ correlation is 0.890. Therefore, the same information remains in the model, but is restricted to a condensed set of EC information. Furthermore, the autoregressive components of CE and EOCV contribute the most to the overall Li plating (an inflection point feature or peak in the dV/dt curve indicated at a block 1414, to the Li-plating case at a block 1416), while larger mean values of CE and EOCV contribute to the probability of SEI-dominant cases (a smooth dV/dt curve indicated at a block 1410, to the SEI-dominant case at a block 1412). Relating this information back to the cell in a more intuitive sense, the mean of the variables describes the initial state of the cell, which may change due to manufacturing or environmental conditions. The first order autoregressive component will be close to zero if the variable is changing linearly with respect to the cycle number while a non-zero coefficient describes an additive behavior with respect to cycle.

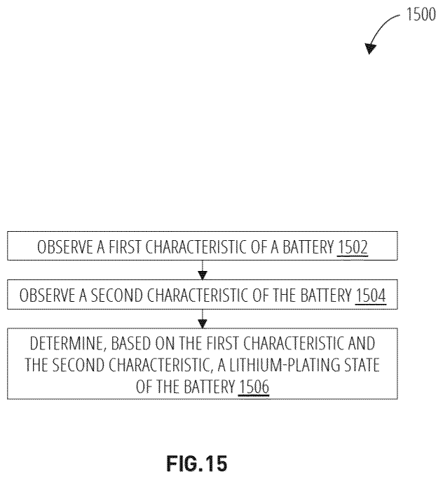

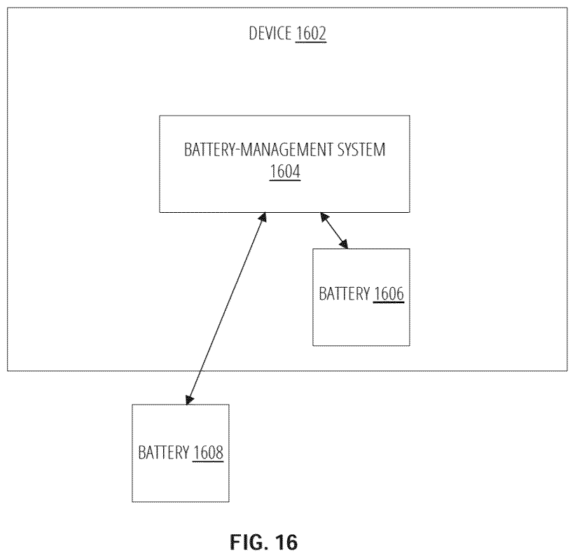

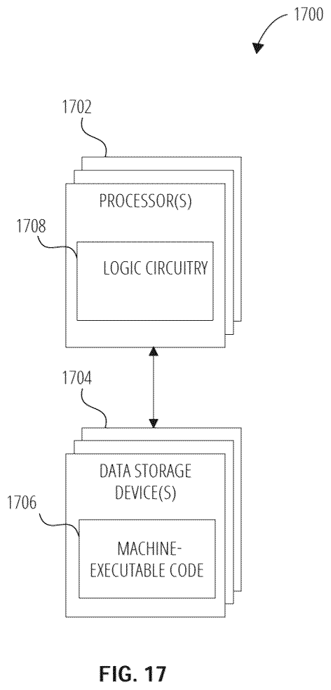

FIG. 15 is a flowchart of an example method 1500, in accordance with various embodiments of the disclosure. At least a portion of method 1500 may be performed, in some embodiments, by a device or system, such as device 1602 of FIG. 16, device 1700 of FIG. 17, or another device or system. Although illustrated as discrete blocks, various blocks may be divided into additional blocks, combined into fewer blocks, or eliminated, depending on the desired implementation.

At a block 1502, a first characteristic of a battery may be observed. At a block 1504, a second characteristic of the battery may be observed. At a block 1506, a lithium-plating state of the battery may be determined based on the first characteristic and the second characteristic.

In some embodiments, method 1500 may further include measuring over time one or more of: voltage of the battery, first current provided by the battery, second current received by the battery, first charge received by the battery, and second charge provided from the battery.

In some embodiments, one of the first characteristic or the second characteristic may be capacity of the battery over a number of cycles, e.g., Q over N. The method may further include determining a rate of change of the capacity per cycle over the number of cycles, e.g., determining a first derivative of capacity with respect to cycle number—dQ/dN. In these or other embodiments, determining the lithium-plating state of the battery may include determining that the battery exhibits lithium plating based on observing a substantially non-linear rate of change of the capacity of the battery over the number of cycles, e.g., a substantially non-linear dQ/dN over N. Additionally or alternatively, determining the lithium-plating state of the battery may include determining that the battery exhibits SEI-dominant aging based on observing a substantially-linearly-increasing rate of change of the capacity of the battery over the number of cycles, e.g., a substantially linear dQ/dN over N.

In some embodiments, one of the first characteristic or the second characteristic may be end-of-charge rest voltage for a number of cycles, e.g., EOCV over N. In these or other embodiments, determining the lithium-plating state of the battery may include determining that the battery exhibits lithium plating based on observing a negative second derivative of the end-of-charge rest voltage with respect to cycles over the number of cycles, e.g., d²EOCV/dN²<0 for some N. Additionally or alternatively, determining the lithium-plating state of the battery may include determining that the battery exhibits lithium plating based on observing a positive correlation between the end-of-charge rest voltage over the number of cycles and a capacity fade over the number of cycles. In these or other embodiments, determining the lithium-plating state of the battery comprises determining that the battery exhibits SEI-dominant aging based on observing a substantially unchanging end-of-charge rest voltage over the number of cycles. Additionally or alternatively, determining the lithium-plating state of the battery may include determining that the battery exhibits SEI-dominant aging based on observing a negative correlation between the end-of-charge rest voltage over the number of cycles and a capacity fade over the number of cycles.

In some embodiments, one of the first characteristic or the second characteristic may be a first amount of charge received by the battery during a cycle and a second amount of charge provided by the battery during the cycle as measured over a number of cycles. In these or other embodiments, method 1500 may include determining a ratio between the first amount of charge and the second amount of charge, e.g., CE. In these or other embodiments, determining the lithium-plating state of the battery may include determining that the battery exhibits lithium plating based on observing the ratio being less than about 0.995 for one or more cycles of the number of cycles and the ratio being greater than or equal to about 0.995 for one or more subsequent cycles of the number of cycles. Additionally or alternatively, determining the lithium-plating state of the battery comprises determining that the battery exhibits SEI-dominant aging based on observing the ratio being greater than about 0.995 for one or more subsequent cycles of the number of cycles.

In some embodiments, a ML algorithm may be used at block 1506 to make determinations based on the first characteristic of block 1502 and the second characteristic of block 1504. The ML algorithm may have been trained using data sets including the first characteristic and the second characteristic. Further, the ML model may be based at least in part on a decision tree, e.g., a decision tree based using the first characteristic and the second characteristic as inputs and providing an Li-plating determination as an output.

In some embodiments, determining the lithium-plating state of the battery of block 1506 may include determining a probability regarding whether substantial lithium plating has occurred at the anode of the battery. In the present disclosure, the term “substantial lithium plating” may refer to a degree to which the anode is Li-plated. Substantial lithium plating may be defined in terms of a percentage of the anode plated, e.g., if more than 10% of the anode is plated with Li, the battery may exhibit substantial lithium plating.

In some embodiments, method 1500 may further include, based on the lithium-plating state of the battery, one or more of: recommending retiring the battery; recommending servicing the battery; changing a usage profile of the battery; and designing a new battery.

In some embodiments, the battery of method 1500, i.e., the battery upon which method 1500 may operate may be a lithium-ion battery.

In some embodiments, method 1500 may additionally include observing a third characteristic of the battery. In these or other embodiments, at block 1506, the lithium-plating state of the battery may be determined based on the first characteristic, the second characteristic, and the third characteristic.

Modifications, additions, or omissions may be made to method 1500 without departing from the scope of the present disclosure. For example, the operations of method 1500 may be implemented in differing order. Furthermore, the outlined operations and actions are only provided as examples, and some of the operations and actions may be optional, combined into fewer operations and actions, or expanded into additional operations and actions without detracting from the essence of the disclosed example.

FIG. 16 is a functional-block diagram of an example device according to one or more embodiments of the present disclosure. Device 1602, including a battery-management system 1604, may be configured to determine a Li-plating state of a battery 1606 and/or a battery 1608. In some embodiments, determining the Li-plating state of battery 1606 and/or battery 1608 may include one or more operations described above with regard to method 1500 of FIG. 15. In some embodiments, battery 1606 and/or battery 1608 may be a lithium-ion battery. The difference between battery 1606 and battery 1608 is that battery 1606 may be part of device 1602 and battery 1608 may be external to device 1602. Thus, device 1602, including battery-management system 1604, may be configured to determine the Li-plating state of battery 1606 internal to device 1602 and/or battery 1608 external to device 1602.

FIG. 17 is a block diagram of an example device 1700 that, in various embodiments, may be used to implement various functions, operations, acts, processes, and/or methods disclosed herein. Device 1700 includes one or more processors 1702 (sometimes referred to herein as “processors 1702”) operably coupled to one or more apparatuses such as data storage devices (sometimes referred to herein as “storage 1704”), without limitation. Storage 1704 includes machine-executable code 1706 stored thereon (e.g., stored on a computer-readable memory) and processors 1702 include logic circuitry 1708. Machine-executable code 1706 include information describing functional elements that may be implemented by (e.g., performed by) logic circuitry 1708. Logic circuitry 1708 is adapted to implement (e.g., perform) the functional elements described by machine-executable code 1706. Device 1700, when executing the functional elements described by machine-executable code 1706, should be considered as special purpose hardware configured for carrying out the functional elements disclosed herein. In various embodiments, processors 1702 may be configured to perform the functional elements described by machine-executable code 1706 sequentially, concurrently (e.g., on one or more different hardware platforms), or in one or more parallel process streams.

When implemented by logic circuitry 1708 of processors 1702, machine-executable code 1706 is configured to adapt processors 1702 to perform operations of embodiments disclosed herein. For example, machine-executable code 1706 may be configured to adapt processors 1702 to perform at least a portion or a totality of method 1500 of FIG. 15. As another example, machine-executable code 1706 may be configured to adapt processors 1702 to perform at least a portion or a totality of the operations discussed for battery-management system 1604.

Processors 1702 may include a general purpose processor, a special purpose processor, a central processing unit (CPU), a microcontroller, a programmable logic controller (PLC), a digital signal processor (DSP), an application specific integrated circuit (ASIC), a field-programmable gate array (FPGA) or other programmable logic device, discrete gate or transistor logic, discrete hardware components, other programmable device, or any combination thereof designed to perform the functions disclosed herein. A general-purpose computer including a processor is considered a special-purpose computer while the general-purpose computer is configured to execute computing instructions (e.g., software code) related to embodiments of the present disclosure. It is noted that a general-purpose processor (may also be referred to herein as a host processor or simply a host) may be a microprocessor, but in the alternative, processors 1702 may include any conventional processor, controller, microcontroller, or state machine. Processors 1702 may also be implemented as a combination of computing devices, such as a combination of a DSP and a microprocessor, a plurality of microprocessors, one or more microprocessors in conjunction with a DSP core, or any other such configuration.

In some embodiments, storage 1704 includes volatile data storage (e.g., random-access memory (RAM)), non-volatile data storage (e.g., Flash memory, a hard disc drive, a solid state drive, erasable programmable read-only memory (EPROM), without limitation). In some embodiments, processors 1702 and storage 1704 may be implemented into a single device (e.g., a semiconductor device product, a system on chip (SOC), without limitation). In some embodiments, processors 1702 and storage 1704 may be implemented into separate devices.

In some embodiments, machine-executable code 1706 may include computer-readable instructions (e.g., software code, firmware code). By way of non-limiting example, the computer-readable instructions may be stored by storage 1704, accessed directly by processors 1702, and executed by processors 1702 using at least logic circuitry 1708. Also by way of non-limiting example, the computer-readable instructions may be stored on storage 1704, transmitted to a memory device (not shown) for execution, and executed by processors 1702 using at least logic circuitry 1708. Accordingly, in some embodiments, logic circuitry 1708 includes electrically configurable logic circuitry.

In some embodiments, machine-executable code 1706 may describe hardware (e.g., circuitry) to be implemented in logic circuitry 1708 to perform the functional elements. This hardware may be described at any of a variety of levels of abstraction, from low-level transistor layouts to high-level description languages. At a high-level of abstraction, a hardware description language (HDL) such as an Institute of Electrical and Electronics Engineers (IEEE) Standard hardware description language (HDL) may be used, without limitation. By way of non-limiting examples, Verilog™, SystemVerilog™ or very large scale integration (VLSI) hardware description language (VHDL™) may be used.

HDL descriptions may be converted into descriptions at any of numerous other levels of abstraction as desired. As a non-limiting example, a high-level description can be converted to a logic-level description such as a register-transfer language (RTL), a gate-level (GL) description, a layout-level description, or a mask-level description. As a non-limiting example, micro-operations to be performed by hardware logic circuits (e.g., gates, flip-flops, registers, without limitation) of logic circuitry 1708 may be described in a RTL and then converted by a synthesis tool into a GL description, and the GL description may be converted by a placement and routing tool into a layout-level description that corresponds to a physical layout of an integrated circuit of a programmable logic device, discrete gate or transistor logic, discrete hardware components, or combinations thereof. Accordingly, in some embodiments, machine-executable code 1706 may include an HDL, an RTL, a GL description, a mask level description, other hardware description, or any combination thereof.

In some embodiments, where machine-executable code 1706 includes a hardware description (at any level of abstraction), a system (not shown, but including storage 1704) may be configured to implement the hardware description described by machine-executable code 1706. By way of non-limiting example, processors 1702 may include a programmable logic device (e.g., an FPGA or a PLC) and the logic circuitry 1708 may be electrically controlled to implement circuitry corresponding to the hardware description into logic circuitry 1708. Also by way of non-limiting example, logic circuitry 1708 may include hard-wired logic manufactured by a manufacturing system (not shown, but including storage 1704) according to the hardware description of machine-executable code 1706.

Regardless of whether machine-executable code 1706 includes computer-readable instructions or a hardware description, logic circuitry 1708 is adapted to perform the functional elements described by machine-executable code 1706 when implementing the functional elements of machine-executable code 1706. It is noted that although a hardware description may not directly describe functional elements, a hardware description indirectly describes functional elements that the hardware elements described by the hardware description are capable of performing.

FIG. 18 includes a plot illustrating overvoltage of example cells. In FIG. 18, a transport plateau can be seen. The presence of a transport overvoltage plateau may be related to battery design and/or operating conditions. Thus, different cells may exhibit differently shaped plateaus. Additionally or alternatively, different operating conditions of similar cells may cause cells to exhibit differently-shaped plateaus.

As used in the present disclosure, the terms “module” or “component” may refer to specific hardware implementations configured to perform the actions of the module or component and/or software objects or software routines that may be stored on and/or executed by general purpose hardware (e.g., computer-readable media, processing devices, without limitation) of the computing system. In some embodiments, the different components, modules, engines, and services described in the present disclosure may be implemented as objects or processes that execute on the computing system (e.g., as separate threads). While some of the system and methods described in the present disclosure are generally described as being implemented in software (stored on and/or executed by general purpose hardware), specific hardware implementations or a combination of software and specific hardware implementations are also possible and contemplated.

As used in the present disclosure, the term “combination” with reference to a plurality of elements may include a combination of all the elements or any of various different sub-combinations of some of the elements. For example, the phrase “A, B, C, D, or combinations thereof” may refer to any one of A, B, C, or D; the combination of each of A, B, C, and D; and any sub-combination of A, B, C, or D such as A, B, and C; A, B, and D; A, C, and D; B, C, and D; A and B; A and C; A and D; B and C; B and D; or C and D.

Terms used in the present disclosure and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to some embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

While the present disclosure has been described herein with respect to certain illustrated some embodiments, those of ordinary skill in the art will recognize and appreciate that the present invention is not so limited. Rather, many additions, deletions, and modifications to the illustrated and described embodiments may be made without departing from the scope of the invention as hereinafter claimed along with their legal equivalents. In addition, features from one embodiment may be combined with features of another embodiment while still being encompassed within the scope of the invention as contemplated by the inventor.

1. A method comprising:
observing a first characteristic of a battery;
observing a second characteristic of the battery; and
determining, based on the first characteristic and the second characteristic, a lithium-plating state of the battery.

2. The method of claim 1, further comprising: observing a third characteristic of the battery, wherein determining the lithium-plating state of the battery comprises determining the lithium plating state of the battery based on the first characteristic, the second characteristic and the third characteristic.

3. The method of claim 1, further comprising measuring over time, three or more of: voltage of the battery, first current provided by the battery, second current received by the battery, first charge received by the battery, or second charge provided from the battery.

4. The method of claim 1, wherein observing the first characteristic comprises measuring capacity of the battery over a number of cycles and determining a rate of change of the capacity per cycle over the number of cycles.

5. The method of claim 4, wherein determining the lithium-plating state of the battery comprises determining that the battery exhibits lithium plating based on observing a substantially non-linear rate of change of the capacity of the battery over the number of cycles.

6. The method of claim 4, wherein determining the lithium-plating state of the battery comprises determining that the battery exhibits solid-electrolyte-interphase-dominant aging based on observing a substantially-linearly-increasing rate of change of the capacity of the battery over the number of cycles.

7. The method of claim 1, wherein observing the first characteristic comprises measuring a voltage at the end of the rest period after charge (EOCV) for a number of cycles.

8. The method of claim 7, wherein determining the lithium-plating state of the battery comprises determining that the battery exhibits lithium plating based on observing a negative second derivative of the (EOCV) with respect to cycles over the number of cycles.

9. The method of claim 7, wherein determining the lithium-plating state of the battery comprises determining that the battery exhibits lithium plating based on observing a positive correlation between the EOCV over the number of cycles and a capacity fade over the number of cycles.

10. The method of claim 7, wherein determining the lithium-plating state of the battery comprises determining that the battery exhibits solid-electrolyte-interphase-dominant aging based on observing a substantially unchanging EOCV over the number of cycles.

11. The method of claim 1, wherein observing the first characteristic comprises measuring, over a number of cycles, a first amount of charge received by the battery during a cycle and a second amount of charge provided by the battery during the cycle and determining a ratio between the first amount of charge and the second amount of charge.

12. The method of claim 11, wherein determining the lithium-plating state of the battery comprises determining that the battery exhibits lithium plating based on observing the ratio being less than 0.995 for one or more cycles of the number of cycles and the ratio being greater than or equal to 0.995 for one or more subsequent cycles of the number of cycles.

13. The method of claim 11, wherein determining the lithium-plating state of the battery comprises determining that the battery exhibits solid-electrolyte-interphase-dominant aging based on observing the ratio being substantially the same over the number of cycles.

14. The method of claim 1, wherein determining the lithium-plating state of the battery comprises using a machine-learning model trained on data sets including the first characteristic and the second characteristic.

15. The method of claim 14, wherein the machine-learning model is based at least in part on a decision tree.

16. The method of claim 1, wherein determining the lithium-plating state of the battery comprises determining a probability regarding whether substantial lithium plating has occurred at an anode of the battery.

17. The method of claim 1, further comprising, based on the lithium-plating state of the battery, one or more of:
recommending retiring the battery;
recommending servicing the battery;
changing a usage profile of the battery; and
designing a new battery.

18. The method of claim 1, wherein the determining the lithium-plating state of the battery comprises determining the lithium-plating state of a lithium-ion battery.

19. A battery-management system comprising:
a processor; and
a computer-readable medium comprising computer executable instructions that, when executed via the processor, cause the processor to perform operations, the operations comprising: observing a first characteristic of a battery;
observing a second characteristic of the battery; and
determining, based on the first characteristic and the second characteristic, a lithium-plating state of the battery.

20. A device comprising:
a battery; and
a battery management system comprising:
a processor; and
a computer-readable medium comprising computer executable instructions that, when executed via the processor, cause the processor to perform operations, the operations comprising: observing a first characteristic of the battery;
observing a second characteristic of the battery; and
determining, based on the first characteristic and the second characteristic, a lithium-plating state of the battery.
